(19) United States
(12) Patent Application Publication
(10) Pub. No.: US 2015/0105113 A1
(43) Pub. Date: Apr. 16, 2015

(54) METHOD FOR D2D TERMINAL TRANSMITTING AND RECEIVING DATA IN WIRELESS COMMUNICATION SYSTEM SUPPORTING DEVICE-TO-DEVICE COMMUNICATION

(71) Applicant: LG ELECTRONICS INC., Seoul (KR)

(72) Inventors: Eunjong Lee, Anyang-si (KR); Hyeyoung Choi, Anyang-si (KR); Heejeong Cho, Anyang-si (KR); Jaehoon Chung, Anyang-si (KR)

(73) Assignee: LG ELECTRONICS INC., Seoul (KR)

(21) Appl. No.: 14/391,270

(22) PCT Filed: Apr. 9, 2013
(86) PCT No.: PCT/KR2013/002957

§ 371 Date: Oct. 8, 2014

Related U.S. Application Data
(60) Provisional application No. 61/621,583, filed on Apr. 9, 2012.
(60) Provisional application No. 61/654,956, filed on Jun. 4, 2012.

(51) Int. Cl. H04W 76/02; H04W 40/24; H04B 7/26

(52) U.S. Cl. CPC H04W 76/021; H04B 7/26; H04W 40/246
USPC 455/500

(57) ABSTRACT

Disclosed is a method for a device-to-device (D2D) terminal establishing a link identifier in a wireless communication system supporting D2D communication. The method for the D2D terminal establishing the link identifier in the wireless communication system supporting D2D communication, comprises the steps of: searching nearby D2D terminals through an navigation slot; selecting a specific D2D terminal from the nearby D2D terminals and forming a D2D terminal link, and establishing the link identifier between the D2D terminal from the nearby D2D terminals and forming a D2D terminal link, and establishing the link identifier between the D2D terminal and the D2D terminal that is linked, wherein the link identifier uses an identifier of the two D2D terminals that are linked or is established as a link identifier which is predetermined in accordance with the location of a signal of the two D2D terminals that are linked inside the navigation slot.

### TECHNICAL FIELD

The present invention relates to a wireless communication, and more particularly, to a method for a D2D user equipment to transmit and data in a wireless communication system supportive of a device-to-device (D2D) communication.

### BACKGROUND ART

Recently, as smartphones and tablet PCs are widely used and multimedia communications of high capacity are activated, mobile traffic increases rapidly. The increasing tendency of the mobile traffic in the future is expected to increase about twice each year. Since most of the mobile traffic is transmitted through a base station, communication service providers are currently confronted with serious network overloads. In order to handle the increasing traffic, the communication service providers increase network equipment investment and commercialize the next generation mobile communication standards (e.g., WiMAX, LTE (long term evolution), etc.) for efficiently handling lots of traffic in a hurry. Yet, in order to bear the amount of traffic expected to increase further rapidly, it is time to seek for other solutions.

D2D (device-to device) communication is a distributive communication technology for directly delivering traffic between adjacent nodes without using such an infrastructure as a base station. In D2D communication environment, each node such as a mobile terminal and the like searches for another user equipment physically adjacent to the corresponding node by itself, establishes a communication session, and then transmits traffic. Thus, since the D2D communication can solve the traffic overload problem in a manner of distributing the traffic focused on a base station, the D2D communication is spotlighted as an elementary technology of the post 4G next generation mobile communication. Such a standardization organization as 3GPP, IEEE and the like is promoting D2D communication standard enactment based on LTE-A or Wi-Fi. And, such a company as Qualcomm and the like is developing an independent D2D communication technology.

As data are transceived between D2D user equipments in D2D system, a method of identifying such data is necessary. However, solutions for this problem have not been proposed yet.

### DISCLOSURE OF THE INVENTION

### Technical Tasks

One technical task achieved by the present invention is to provide a method for a D2D user equipment to transmit data in a wireless communication system supportive of a device-to-device (D2D) communication.

Another technical task achieved by the present invention is to provide a method for a D2D user equipment to receive data in a wireless communication system supportive of a device-to-device (D2D) communication.

Further technical task achieved by the present invention is to provide a D2D user equipment capable of transmitting data in a wireless communication system supportive of a device-to-device (D2D) communication.

Another further technical task achieved by the present invention is to provide a D2D user equipment capable of receiving data in a wireless communication system supportive of a device-to-device (D2D) communication.

Technical tasks obtainable from the present invention may be non-limited by the above mentioned technical tasks. And, other unmentioned technical tasks can be clearly understood from the following description by those having ordinary skill in the technical field to which the present invention pertains.

### Technical Solutions

To achieve these and other advantages and in accordance with the purpose of the present invention, as embodied and broadly described, a method of setting a link identifier by a D2D (device-to-device) user equipment in a wireless communication system supportive of a D2D communication, according to one embodiment of the present invention includes searching neighbor D2D user equipments through a discovery slot and establishing a D2D user equipment link by selecting a specific D2D user equipment from the neighbor D2D user equipments and setting the link identifier between the D2D user equipment and the linked D2D user equipment, wherein the link identifier is set using identifiers of the linked two D2D user equipments or set to a predefined link identifier in accordance with a location of a signal of the linked two D2D user equipments within the discovery slot. If the link identifier uses the identifiers of the liked two D2D user equipments or is set, the link identifier is configured with a combination of the identifiers of the linked two D2D user equipments. The the set link identifier includes one of a unique value in a coverage of the two D2D user equipments and a MAC (media access control) address. The method may further include the step of transmitting data including the set link identifier.

To further achieve these and other advantages and in accordance with the purpose of the present invention, as embodied and broadly described, a method of setting a link identifier by a D2D (device-to-device) user equipment in a wireless communication system supportive of a D2D communication, according to one embodiment of the present invention includes the steps of searching neighbor D2D user equipments through a discovery slot, establishing a D2D user equipment link by selecting a specific D2D user equipment from the neighbor D2D user equipments, requesting a base station to assign a link identifier to use between the linked D2D user equipments, and receiving the assigned link identifier from the base station and setting the received link identifier as the link identifier for the two D2D user equipments, wherein the set link identifier is selected from unused link identifiers neighboring to the two D2D user equipments.

To further achieve these and other advantages and in accordance with the purpose of the present invention, as embodied and broadly described, a D2D (device-to-device) user equipment of setting a link identifier in a wireless communication system supportive of a D2D communication according to one embodiment of the present invention includes a processor configured to search neighbor D2D user equipments through a discovery slot, the processor configured to establish a D2D user equipment link by selecting a specific D2D user equipment from the neighbor D2D user equipments, the processor configured to set the link identifier between the D2D user equipment and the linked D2D user equipment, wherein the link identifier is set using identifiers of the linked two D2D user equipments or set to a predefined link identifier in accordance with a location of a signal of the linked two D2D user equipments within the discovery slot. If the link identifier uses the identifiers of the liked two D2D user equipments or is set, the link identifier is configured with a combination of the identifiers of the linked two D2D user equipments. The D2D user equipment may further include a transmitter configured to transmit data including the set link identifier.

To further achieve these and other advantages and in accordance with the purpose of the present invention, as embodied and broadly described, a D2D (device-to-device) user equipment of setting a link identifier in a wireless communication system supportive of a D2D communication according to another embodiment of the present invention includes a transmitter, a receiver, and a processor configured to search neighbor D2D user equipments through a discovery slot, the processor configured to establish a D2D user equipment link by selecting a specific D2D user equipment from the neighbor D2D user equipments, the processor configured to control the transmitter to request a base station to assign a link identifier to use between the linked D2D user equipments, the processor configured to control the receiver to receive the assigned link identifier from the base station, the processor configured to set the received link identifier as the link identifier for the two D2D user equipments, wherein the set link identifier is selected from unused link identifiers neighboring to the two D2D user equipments.

### Advantageous Effects

According to embodiments of the present invention, as system resource use efficiency in a D2D communication system is improved, system performance is raised.

Effects obtainable from the present invention may be non-limited by the above mentioned effect. And, other unmentioned effects can be clearly understood from the following description by those having ordinary skill in the technical field to which the present invention pertains.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention.

FIG. 1 is a block diagram for configurations of a base station 105 and a user equipment 110 in a wireless communication system 100.

FIG. 2(a) and FIG. 2(b) are diagrams for examples to describe a network centralized D2D communication type and a distributive D2D communication type in accordance with a network coordinated D2D communication type, respectively.

FIG. 2(c) is a diagram for one example to describe a concept of an autonomous D2D communication type.

FIG. 3 is a diagram for one example of a frame structure applicable to an autonomous D2D communication type.

FIG. 4 is a diagram for one example to describe that a D2D user equipment broadcasts a peer discovery signal.

FIG. 5 is a diagram for one example to describe a process for a transmitting D2D user equipment and a receiving D2D user equipment to occupy a traffic slot.

FIG. 6 is a diagram for one example to describe a connection scheme applied between user equipments.

FIG. 7 is a diagram for one example to describe a link ID setup between D2D user equipments.

FIG. 8(a) and FIG. 8(b) are diagrams of discovery slots discovered by a D2D user equipment A and a D2D user equipment B, respectively. And, FIG. 8(c) is a diagram of a location scenario of user equipments neighboring to a D2D user equipment A and a D2D user equipment B.

FIG. 9A is a diagram of a MAC data structure including a MAC header in LTE system.

FIG. 9B is a diagram of a MAC data structure including a MAC header in IEEE 802.16m system.

FIG. 10 is a diagram for one example to describe a data transmitting method using multiple CIDs.

FIG. 11 is a diagram for one example to describe a channel state transmitting method using Link ID or CID.

FIG. 12A is a diagram to describe a method of performing a data communication between user equipments according to a related art. And, FIG. 12B is a diagram to describe a method of performing a data communication between D2D user equipments.

### BEST MODE FOR INVENTION

Reference will now be made in detail to the preferred embodiments of the present invention, examples of which are illustrated in the accompanying drawings. In the following detailed description of the invention includes details to help the full understanding of the present invention. Yet, it is apparent to those skilled in the art that the present invention can be implemented without these details. For instance, although the following descriptions are made in detail on the assumption that a mobile communication system includes 3GPP LTE system, the following descriptions are applicable to other random mobile communication systems in a manner of excluding unique features of the 3GPP LTE.

Occasionally, to prevent the present invention from getting vaguer, structures and/or devices known to the public are skipped or can be represented as block diagrams centering on the core functions of the structures and/or devices. Wherever possible, the same reference numbers will be used throughout the drawings to refer to the same or like parts.

Besides, in the following description, assume that a terminal is a common name of such a mobile or fixed user stage device as a user equipment (UE), a mobile station (MS), an advanced mobile station (AMS) and the like. And, assume that a base station (BS) is a common name of such a random node of a network stage communicating with a terminal as a Node B (NB), an eNode B (eNB), an access point (AP) and the like. Although the present specification is described based on 3GPP LTE system or 3GPP LTE-A system, contents of the present invention may be applicable to various kinds of other communication systems.

In a mobile communication system, a user equipment is able to receive information in downlink and is able to transmit information in uplink as well. Informations transmitted or received by the user equipment node may include various kinds of data and control informations. In accordance with types and usages of the informations transmitted or received by the user equipment, various physical channels may exist.

The following descriptions are usable for various wireless access systems including CDMA (code division multiple access), FDMA (frequency division multiple access), TDMA (time division multiple access), OFDMA (orthogonal frequency division multiple access), SC-FDMA (single carrier frequency division multiple access) and the like. CDMA can be implemented by such a radio technology as UTRA (universal terrestrial radio access), CDMA 2000 and the like. TDMA can be implemented with such a radio technology as GSM/GPRS/EDGE (Global System for Mobile communications)/General Packet Radio Service/Enhanced Data Rates for GSM Evolution). OFDMA can be implemented with such a radio technology as IEEE 802.11 (Wi-Fi), IEEE 802.16 (WiMAX), IEEE 802.20, E-UTRA (Evolved UTRA), etc. UTRA is a part of UMTS (Universal Mobile Telecommunications System). 3GPP (3rd Generation Partnership Project) LTE (long term evolution) is a part of E-UMTS (Evolved UMTS) that uses E-UTRA. The 3GPP LTE employs OFDMA in DL and SC-FDMA in UL. And, LTE-A (LTE-Advanced) is an evolved version of 3GPP LTE.

Moreover, in the following description, specific terminologies are provided to help the understanding of the present invention. And, the use of the specific terminology can be modified into another form within the scope of the technical idea of the present invention.

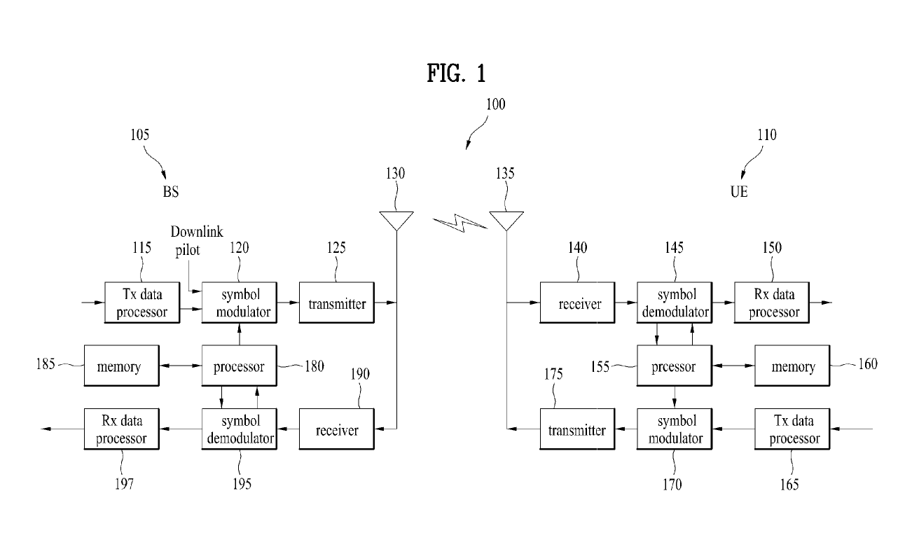

FIG. 1 is a block diagram for configurations of a base station 105 and a user equipment 110 in a wireless communication system 100.

Although one base station 105 and one user equipment 110 (D2D user equipment included) are shown in the drawing to schematically represent a wireless communication system 100, the wireless communication system 100 may include at least one base station and/or at least one user equipment.

Referring to FIG. 1, a base station 105 may include a transmitted (Tx) data processor 115, a symbol modulator 120, a transmitter 125, a transceiving antenna 130, a processor 180, a memory 185, a receiver 190, a symbol demodulator 195 and a received data processor 197. And, a user equipment 110 may include a transmitted (Tx) data processor 165, a symbol modulator 170, a transmitter 175, a transceiving antenna 135, a processor 155, a memory 160, a receiver 140, a symbol demodulator 155 and a received data processor 150. Although the base station/user equipment 105/110 includes one antenna 130/135 in the drawing, each of the base station 105 and the user equipment 110 includes a plurality of antennas. Therefore, each of the base station 105 and the user equipment 110 of the present invention supports an MIMO (multiple input multiple output) system. And, the base station 105 according to the present invention may support both SU-MIMO (single user-MIMO) and MU-MIMO (multi user-MIMO) systems.

In downlink, the transmitted data processor 115 receives traffic data, codes the received traffic data by formatting the received traffic data, interleaves the coded traffic data, modulates (or symbol maps) the interleaved data, and then provides modulated symbols (data symbols). The symbol modulator 120 provides a stream of symbols by receiving and processing the data symbols and pilot symbols.

The symbol modulator 120 multiplexes the data and pilot symbols together and then transmits the multiplexed symbols to the transmitter 125. In doing so, each of the transmitted symbols may include the data symbol, the pilot symbol or a signal value of zero. In each symbol duration, pilot symbols may be contiguously transmitted. In doing so, the pilot symbols may include symbols of frequency division multiplexing (FDM), orthogonal frequency division multiplexing (OFDM), or code division multiplexing (CDM).

The transmitter 125 receives the stream of the symbols, converts the received stream to at least one or more analog signals, additionally adjusts the analog signals (e.g., amplification, filtering, frequency upconverting), and then generates a downlink signal suitable for a transmission on a radio channel. Subsequently, the downlink signal is transmitted to the user equipment via the antenna 130.

In the configuration of the user equipment 110, the receiving antenna 135 receives the downlink signal from the base station and then provides the received signal to the receiver 140. The receiver 140 adjusts the received signal (e.g., filtering, amplification and frequency downconverting), digitizes the adjusted signal, and then obtains samples. The symbol demodulator 145 demodulates the received pilot symbols and then provides them to the processor 155 for channel estimation.

The symbol demodulator 145 receives a frequency response estimated value for downlink from the processor 155, performs data demodulation on the received data symbols, obtains data symbol estimated values (i.e., estimated values of the transmitted data symbols), and then provides the data symbols estimated values to the received (Rx) data processor 150. The received data processor 150 reconstructs the transmitted traffic data by performing demodulation (i.e., symbol demapping, deinterleaving and decoding) on the data symbol estimated values.

The processing by the symbol demodulator 145 and the processing by the received data processor 150 are complementary to the processing by the symbol modulator 120 and the processing by the transmitted data processor 115 in the base station 105, respectively.

In the user equipment 110 in uplink, the transmitted data processor 165 processes the traffic data and then provides data symbols. The symbol modulator 170 receives the data symbols, multiplexes the received data symbols, performs modulation on the multiplexed symbols, and then provides a stream of the symbols to the transmitter 175. The transmitter 175 receives the stream of the symbols, processes the received stream, and generates an uplink signal. This uplink signal is then transmitted to the base station 105 via the antenna 135.

In the base station 105, the uplink signal is received from the user equipment 110 via the antenna 130. The receiver 190 processes the received uplink signal and then obtains samples. Subsequently, the symbol demodulator 195 processes the samples and then provides pilot symbols received in uplink and a data symbol estimated value. The received data processor 197 processes the data symbol estimated value and then reconstructs the traffic data transmitted from the user equipment 110.

The processor 155/180 of the user equipment/base station 110/105 directs operations (e.g., control, adjustment, management, etc.) of the user equipment/base station 110/105. The processor 155/180 may be connected to the memory unit 160/185 configured to store program codes and data. The memory 160/185 is connected to the processor 155/180 to store operating systems, applications and general files.

The processor 155/180 may be called one of a controller, a microcontroller, a microprocessor, a microcomputer and the like. And, the processor 155/180 may be implemented using hardware, firmware, software and/or any combinations thereof. In the implementation by hardware, the processor 155/180 may be provided with such a device configured to implement the present invention as ASICs (application specific integrated circuits), DSPs (digital signal processors), DSPDs (digital signal processing devices), PLDs (programmable logic devices), FPGAs (field programmable gate arrays), and the like.

Meanwhile, in case of implementing the embodiments of the present invention using firmware or software, the firmware or software may be configured to include modules, procedures, and/or functions for performing the above-explained functions or operations of the present invention. And, the firmware or software configured to implement the present invention is loaded in the processor 155/180 or saved in the memory 160/185 to be driven by the processor 155/180.

Layers of a radio protocol between a user equipment/base station and a wireless communication system (network) may be classified into 1^{st} layer L1, 2^{nd} layer L2 and 3^{rd} layer L3 based on 3 lower layers of OSI (open system interconnection) model well known to communication systems. A physical layer belongs to the 1^{st} layer and provides an information transfer service via a physical channel. RRC (radio resource control) layer belongs to the 3^{rd} layer and provides control radio resourced between UE and network. A user equipment and a base station may be able to exchange RRC messages with each other through a wireless communication network and RRC layers.

In the present specification, although the processor 155/180 of the user equipment/base station performs an operation of processing signals and data except a function for the user equipment/base station 110/105 to receive or transmit a signal, for clarity, the processors 155 and 180 will not be mentioned in the following description specifically. In the following description, the processor 155/180 can be regarded as performing a series of operations such as a data processing and the like except a function of receiving or transmitting a signal without being specially mentioned.

In the following description, various embodiments for a user equipment to perform a device-to-device communication (hereinafter named a D2D communication or a D2D direct communication) are explained. In describing a D2D communication, 3GPP LTE/LTE-A is taken as an example for the detailed description. Moreover, the D2D communication is applicable to other communication systems (e.g., IEEE 802.16, WiMAC, etc.).

In the present specification, for clarity of the description, a user equipment supportive of a D2D communication (i.e., a device-to-device direct communication) or a user equipment capable of performing the D2D communication shall be named a D2D user equipment. In case that a transmitting end and a receiving end need to be discriminated from each other, a D2D user equipment transmitting or attempting to transmit data to a different D2D user equipment using a radio resource given to a D2D link on performing a D2D communication shall be named a transmitting D2D user equipment. And, a user equipment receiving or attempting to receive the data from the transmitting D2D user equipment shall be named a receiving D2D user equipment. If a plurality of receiving D2D user equipments receiving or attempting to receive data from a transmitting D2D user equipment exist, a plurality of the receiving D2D user equipments can be identified from each other using ordinal numbers including ‘1^{st} to N^{th}’. Moreover, for clarity of the following description, such a random node at a network end as a base station configured to control a connection between D2D user equipments or allocate a radio resource to a D2D link, a D2D server, a connection/session management server and the like shall be named ‘network’.

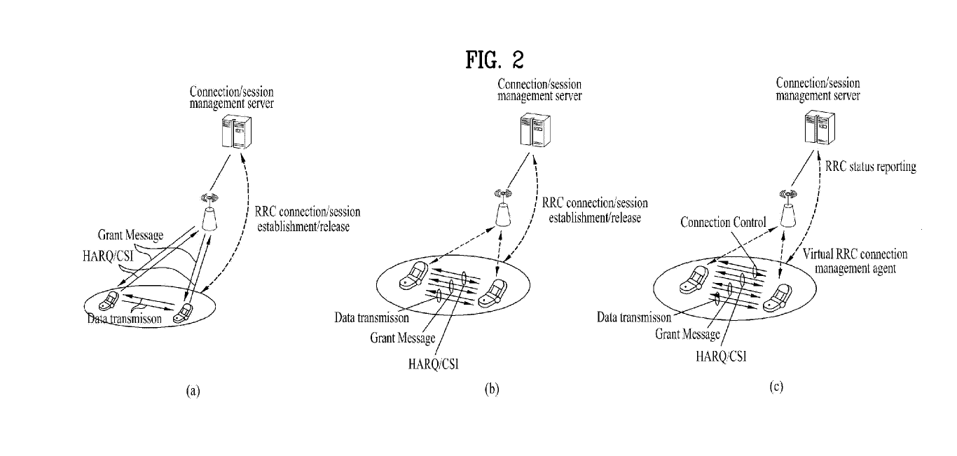

FIG. 2 is a diagram for examples to describe various embodiments of a D2D communication.

D2D communication can be sorted into a network coordinated D2D communication type or an autonomous D2D communication type depending on a presence or non-presence of performing the D2D communication under the control of a network. The network coordinated D2D communication can be further sorted into a data-only-in-D2D type or a connection-control-only-in-network type depending on a level of network involvement. For clarity of the description, the data-only-in-D2D type shall be named ‘network centralized D2D communication type’ and the connection-control-only-in-network type shall be named ‘distributive D2D communication type’.

FIG. 2(a) and FIG. 2(b) are diagrams for examples to describe a network centralized D2D communication type and a distributive D2D communication type in accordance with a network coordinated D2D communication type, respectively.

According to the network centralized D2D communication type shown in FIG. 2(a), only data are exchanged between D2D user equipments, while a connection control between D2D user equipments and a radio resource allocation (grant message) are performed by a network. The D2D user equipments can transceive data or specific control information using a radio resource allocated by the network.

For instance, HARQ ACK/NACK feedback for a data reception between D2D user equipments or channel state information (CSI) can be transmitted to another D2D user equipment through a network instead of being directly exchanged between the D2D user equipments. In particular, if a network establishes a D2D link between D2D user equipments and allocates a radio resource to the established D2D link, a transmitting D2D user equipment and a receiving D2D user equipment are able to perform a D2D communication using the allocated radio resource.

Namely, according to the network centralized D2D communication type, a D2D communication between D2D user equipments is controlled by a network. And, the D2D user equipments are able to perform the D2D communication using a radio resource allocated by the network.

According to the distributive D2D communication type shown in FIG. 2(b), a network performs a role more limited than that of a network according to the network centralized D2D communication type. According to the distributive D2D communication type, a network performs a control of connection between D2D user equipments. Yet, a radio resource allocation (grant message) between the D2D user equipments can be occupied by the D2D user equipments through contentions between the D2D user equipments without the help of the network.

For instance, HARQ ACK/NACK feedback for a data reception between D2D user equipments or channel state information can be directly exchanged between the D2D user equipments without passing through a network.

As mentioned in the foregoing description of the example, a D2D communication can be sorted into a network centralized D2D communication type or a distributive D2D communication type depending on a level of network D2D communication involvement. In this case, a common feature between the network centralized D2D communication type and the distributive D2D communication type lies in that a D2D connection control can be performed by a network.

In particular, according to a network coordinated D2D communication type, a network can establish a connection between D2D user equipments by establishing a D2D link between the D2D user equipments attempting to perform a D2D communication. In establishing the D2D link between the D2D user equipments, the network can give a physical D2D link identifier (LID) to the established D2D link. In this case, when a plurality of D2D links exist between a plurality of D2D user equipments, the physical D2D ink identifier can be used as an identifier for identifying each of the D2D links.

FIG. 2(c) is a diagram for one example to describe a concept of an autonomous D2D communication type.

According to an autonomous D2D communication type, unlike a network centralized or distributive D2D communication type, D2D user equipments can freely perform a D2D communication without the help of a network. In particular, according to the autonomous D2D communication type, unlike the network centralized or distributive D2D communication type, a connection control, a radio resource occupation and the like can be autonomously performed by a D2D user equipment. If necessary, the network may provide the D2D user equipment with D2D channel information available for a corresponding cell.

Based on a frame structure mentioned in the following description, the autonomous D2D communication type shall be described in detail as follows.

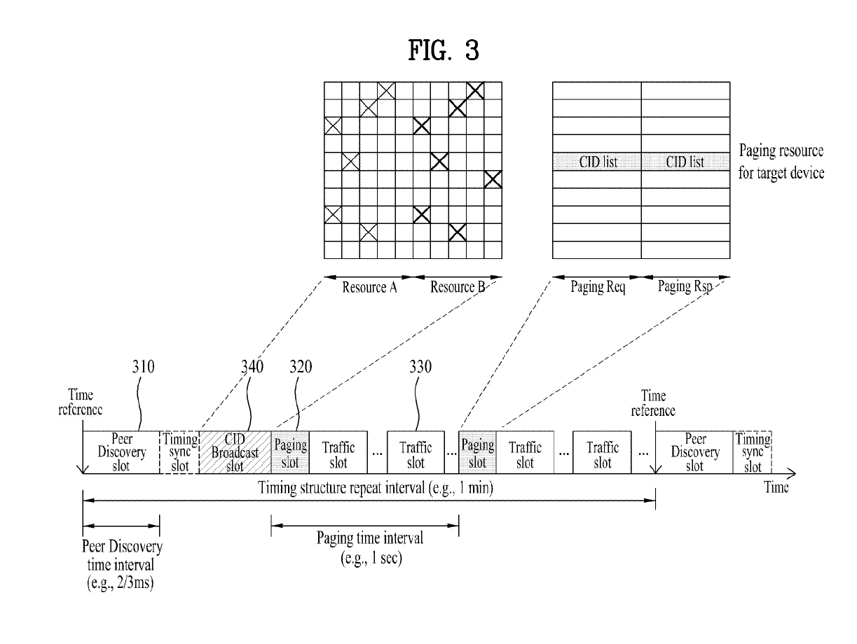

FIG. 3 is a diagram for one example of a frame structure applicable to an autonomous D2D communication type.

First of all, according to an autonomous D2D communication type, a D2D user equipment may be able to perform a D2D communication using a frame shown in FIG. 3 for example. Like the example shown in FIG. 3, a frame applicable to an autonomous D2D communication type may include a peer discovery slot 310, a paging slot 320 and a traffic slot 330. In some cases, the frame applicable to the autonomous D2D communication type may further include a CID (connection identification) broadcast slot 340.

The peer discovery slot 310 is an interval provided to enable a D2D user equipment to detect a different D2D user equipment nearby and broadcast its presence to the different D2D user equipment nearby. A single peer discovery slot 310 includes a plurality of logical channels. The D2D user equipment can share the peer discovery slot 310 with a different D2D user equipment through broadcasting and listening. In particular, the D2D user equipment listens to a logical channel occupied by the different D2D user equipment from the different D2D user equipment nearby, thereby being able to recognize that a specific one of a plurality of the logical channels of the peer discovery slot 310 is currently used or that a specific one of a plurality of the logical channels is vacant. In some cases, a broadcast listening available range of a D2D user equipment may be limited to a neighbor D2D user equipment within 1 hop centering on itself Yet, the listening available range of the D2D user equipment needs not to be necessarily limited to the neighbor D2D user equipment within 1 hop.

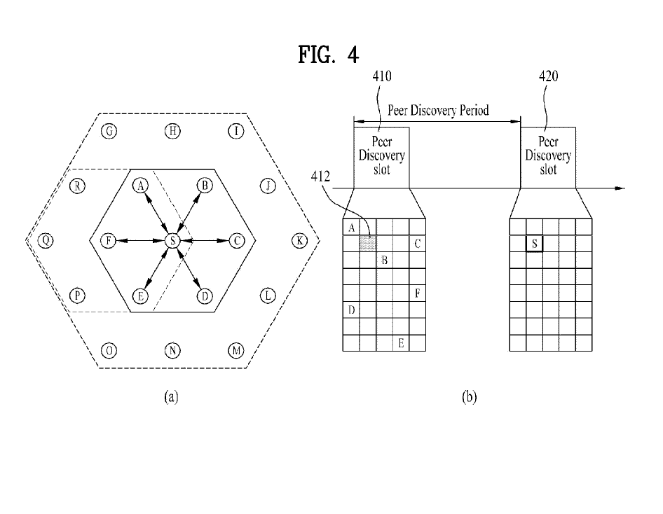

Having listened to a logical channel occupied by a different D2D user equipment from a different D2D user equipment nearby, the D2D user equipment is able to randomly select one of vacant logical channels of the 1^{st} peer discovery slot 310. Subsequently, the D2D user equipment is able to broadcast a peer discovery signal for announcing the logical channel selected by the D2D user equipment on the selected logical channel through a next peer discovery slot. A process for the D2D user equipment to broadcast the peer discovery signal is described in detail with reference to FIG. 4 as follows.

FIG. 4 is a diagram for one example to describe that a D2D user equipment broadcasts a peer discovery signal.

First of all, like the example shown in FIG. 4(a), assume that a D2D user equipments A (denoted by A) to a D2D user equipment R (denoted by R) exist around a D2D user equipment S (denoted by S). In this case, assume that the D2D user equipment A to the D2D user equipment F (denoted by F) are neighbor user equipments located within 1 hop with reference to the D2D user equipment S. And, assume that the D2D user equipment G (denoted by G) to the D2D user equipment R are neighbor user equipments located within 2 hops with reference to the D2D user equipment S.

In the environment shown in FIG. 4(a), if a D2D user equipment is able to listen to a broadcast from a neighbor D2D user equipment within 1 hop, the D2D user equipment S may be able to listen to a logical channel occupied by the D2D user equipments A to F in a 1^{st} peer discovery slot 410. Having listened to the logical channel occupied by the D2D user equipments A to F, the D2D user equipment S can randomly select one of logical channels vacant in the peer discovery slot based on the listened broadcast [e.g., in FIG. 4(b), a logical channel denoted by ‘412’ is selected]. Thereafter, like the example shown in FIG. 4(b), the D2D user equipment S (denoted by S) can broadcast a peer discovery signal using the logical channel randomly selected from a 2^{nd} peer discovery slot 420.

Each of the D2D user equipments A to F listening to the logical channel selected by the D2D user equipment S is able to detect a presence or non-presence of collision of the logical channel selected by the D2D user equipment S. For instance, when the D2D user equipment F listens to the broadcasts from the D2D user equipments A, E and P to R, the D2D user equipment F is able to detect whether the logical channel selected by the D2D user equipment S collides with a logical channel of each of the D2D user equipments A, E and P to R. In case that the logical channel selected by the D2D user equipment S collides with the logical channel of the D2D user equipment Q, the D2D user equipment F transmits a notification signal notifying that the logical channel collision has been detected to the D2D user equipment S. Subsequently, the D2D user equipment S is then able to select a new logical channel in accordance with the notification signal.

On the other hand, if the logical channel selected by the D2D user equipment S avoids the collision, the D2D user equipment can keep broadcasting the peer discovery signal through the selected logical channel.

If the D2D user equipment F determines the collision with the logical channel occupied by the neighbor D2D user equipment Q, the D2D user equipment F transmits a notification signal notifying the detection of the collision to the D2D user equipment S so that the D2D user equipment S can select a new logical channel.

The CID broadcast slot 340 shown in FIG. 3 is provided to enable a D2D user equipment to listen to a CID currently used by a different D2D user equipment and to broadcast a CID currently used by itself In particular, in order to announce a CID currently used by itself or a CID desired to be used by itself, the D2D user equipment is able to broadcast a CID broadcast signal through a CID resource of the CID broadcast slot 340. The D2D user equipment is able to set a CID to use through the paging slot 320 mentioned in the following description.

The paging slot 320 shown in FIG. 3 is provided to configure a CID between a transmitting D2D user equipment and a receiving D2D user equipment. The paging slot 320 for configuring the CI may include a paging request interval and a paging response interval. For the CID configuration between the transmitting D2D user equipment and the receiving D2D user equipment, one of the transmitting D2D user equipment and the receiving D2D user equipment operates as a paging initiator user equipment and the other can operate as a paging target user equipment.

The paging initiator user equipment is able to create a 1^{st} CID list containing at least one of vacant broadcast resources (i.e., unused CIDs) based on a CID listened to through the CID broadcast slot 340. Once the 1^{st} CID list is created, the paging initiator user equipment can transmit the 1^{st} CID list to the paging target user equipment using a paging resource of the paging initiator user equipment or a paging resource of the paging target user equipment.

In this case, the paging resource can be determined by a device identifier (Device ID) of the paging initiator user equipment or the paging target user equipment. A paging resource between D2D user equipments may be identifies by time-frequency or orthogonal code, by which the paging resource may be non-limited.

In the paging response interval, the paging target user equipment creates a 2^{nd} CID list containing at least one vacant broadcast resource based on a CID listened to through its own CID broadcast slot 340 and is then able to transmit the 2^{nd} CID list to the paging initiator user equipment using its own paging resource or a paging resource of the paging initiator user equipment.

Each of the paging initiator user equipment and the paging target user equipment selects an available CID candidate group based on the 1^{st} CID list and the 2^{nd} CID list, selects a prescribed CID from the available CID candidate group, and is then able to broadcast a CID broadcast signal through a CID resource of the CID broadcast slot 440 in order to announce the selected CID.

Thereafter, each of the paging initiator user equipment and the paging target user equipment is able to determine whether the selected CID is currently used by a different D2D user equipment through a next CID broadcast slot 340. In particular, each of the paging initiator user equipment and the paging target user equipment is able to determine whether the selected CID is currently used by comparing signal strengths for the same tone of different CID resources.

If it is determined that the selected CID is currently used, each of the paging initiator user equipment and the paging target user equipment is able to select a different CID. Otherwise, if it is determined that the selected CID is not currently used, each of the paging initiator user equipment and the paging target user equipment is able to activate the selected CID. Only if both of the paging initiator user equipment and the paging target user equipment activate the selected CID, the selected CID can be configured as a CID between the paging initiator user equipment and the paging target user equipment.

Unlike the network centralized D2D communication type or the distributive D2D communication type, a D2D user equipment in the autonomous D2D communication type autonomously performs a control of a connection to a different D2D user equipment. Hence, according to the autonomous D2D communication type, a D2D link ID cannot be assigned by a network. According to the autonomous D2D communication type, a D2D user equipment is able to perform a D2D communication by configuring a CID with a different D2D user equipment through the paging slot 320 instead of receiving assignment of a D2D link ID.

Once the CID configuration between the transmitting D2D user equipment and the receiving D2D user equipment is completed through the paging slot 320, the transmitting D2D user equipment and the receiving D2D user equipment can perform a data transceiving using the traffic slot 330. In doing so, the transmitting D2D user equipment and the receiving D2D user equipment can occupy the traffic slot 330 through contention with other D2D link. In case of occupying the traffic slot 330, the transmitting D2D user equipment and the receiving D2D user equipment can transceive data with each other using the occupied traffic slot 330.

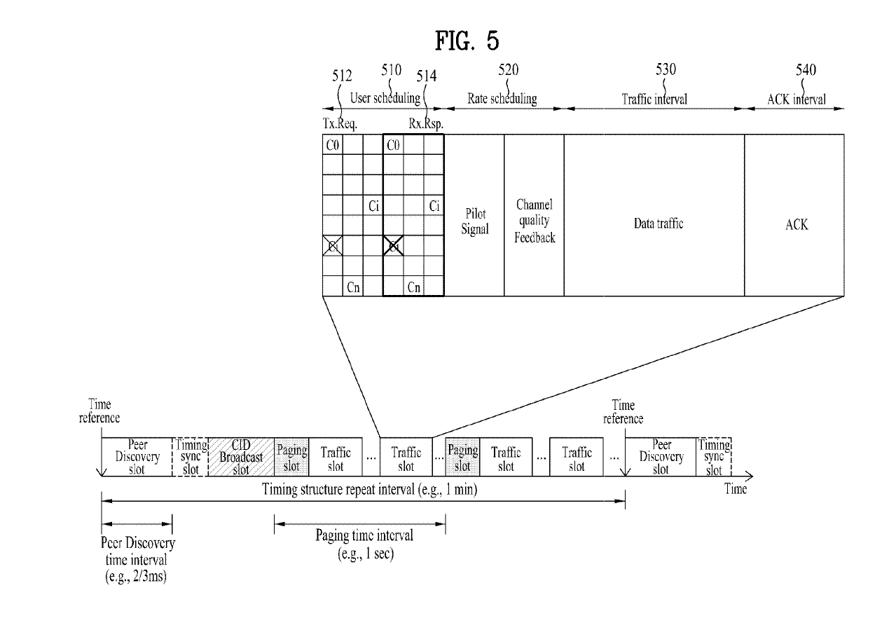

A process for the transmitting D2D user equipment and the receiving D2D user equipment to occupy the traffic slot 330 shall be described in detail with reference to FIG. 5 as follows.

FIG. 5 is a diagram for one example to describe a process for a transmitting D2D user equipment and a receiving D2D user equipment to occupy a traffic slot.

Referring to FIG. 5, the traffic slot 330 can include a user scheduling interval 510, a rate scheduling interval 520, a traffic interval 530 and an ACK interval 540.

The user scheduling interval 510 is provided to transceive a signal for the transmitting D2D user equipment and the receiving D2D user equipment to occupy the corresponding traffic slot 330. And, the user scheduling interval may include a transmission request interval (Tx Req) 512 and a reception response interval (Rx Res) 514. First of all, in the transmission request interval 512, the transmitting D2D user equipment is able to transmit a request signal to the receiving D2D user equipment through a resource corresponding to a selected CID using the CID selected through the paging slot 320.

The receiving D2D user equipment, which shares the same CID with the transmitting D2D user equipment, receives the request signal. If the receiving D2D user equipment determines that a data transmission is possible by a preset contention rule, the receiving D2D user equipment is able to transmit a response signal to the transmitting D2D user equipment through a resource corresponding to the CID in the response interval 514.

The receiving D2D user equipment having received the request signal successfully and the transmitting D2D user equipment having received the response signal successfully can determine that the corresponding traffic slot 330 is occupied. In case of determining that the traffic slot 330 is occupied, the transmitting D2D user equipment can transmit a pilot signal (or a reference signal) to the receiving D2D user equipment in the rate scheduling interval 520. Having received the pilot signal from the transmitting D2D user equipment, the receiving D2D user equipment can obtain a channel state for the pilot signal. In particular, the receiving D2D user equipment obtains a channel state (e.g., CQI (channel quality information), CSI (channel state information), SINR (signal to interference plus noise to ratio), etc.) and is then able to feed back the obtained channel state to the transmitting D2D user equipment having transmitted the pilot signal.

Having received the channel state from the receiving D2D user equipment, the transmitting D2D user equipment can determine whether to transmit data to the receiving D2D user equipment using a D2D traffic resource in the traffic interval 530. For instance, if a measured CQI or SINR is smaller or lower than a preset threshold, the transmitting D2D user equipment does not transmit the data in the traffic interval but is able to attempt an occupation of a next traffic slot 330.

If the transmitting D2D user equipment transmits the data using the traffic resource in the traffic interval 530, the receiving D2D user equipment is able to transmit ACK or NACK depending on a presence or non-presence of a successful data reception in the response interval 540.

In general, terminologies used for the description of the present invention can be used as the following meanings.

First of all, Link ID (LID) is an identifier set for a connection to recognize each user equipment. The LID is an identifier assigned to a physical connection between user equipments and is a unique ID in a specific area. For instance, the LID may include one of STID (station identifier) of IEEE 802.16 system and C-RNTI (cell radio network temporary identifier).

Connection ID (CID) is an identifier assigned to at least one service flow settable between user equipments. For instance, the CID may include one of a connection ID on a MAC layer in IEEE 802.16e system, a flow ID (FLOW ID) on a MAC layer in IEEE 802.16m system, a logical channel ID (LCID) meant in LTE and a DRB identity. In particular, the CID is LCID on a MAC layer or a DRB (data ratio bearer) ID on an ELC layer.

Link ID or Connection ID used by the present invention can be set to a bi-directional or uni-directional ID. In particular, in case of bi-direction, Link/Connection ID set once means that each of two user equipments can play a role as a transmitter or a receiver and data transceived between the two user equipments can use a single Link/Connection ID. Yet, in case of being used as a uni-directional ID, Link/Connection ID set once means that a user equipment having initiated a link or connection operates as a transmitting user equipment (or a source user equipment) and that a target user equipment operates as a receiving user equipment. In case that a target user equipment has data to transmit to a source user equipment, the target user equipment establishes a new Link/Connection and is able to transmit the data using an additional Link/Connection ID.

In case that at least one connection is established between two user equipments, a CID scheme is described as follows. According to a related art, all connections are handled as independent connections, respectively.

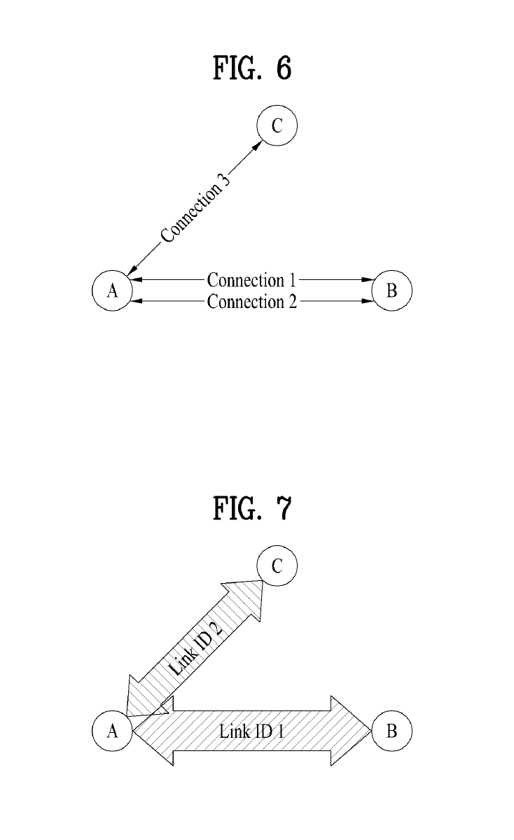

FIG. 6 is a diagram for one example to describe a connection scheme applied between user equipments.

Referring to FIG. 6, 2 active connections (i.e., Connection 1 and Connection 2) exist between a user equipment A (denoted by A) and a user equipment B (denoted by B) and 1 active connection (i.e., Connection 3) exists between the user equipment A and a user equipment C. According to a related art, when 3 active connections exist nearby the user equipment A, the user equipment B and the user equipment C, as shown in FIG. 6, each of the user equipments is not aware that 3 active connections exist nearby and that the rest of the connections except the connection(s) connected to the corresponding user equipment are provided for which user equipment(s). Hence, although a connection is provided for a same user equipment, it is recognized as a connection for a different user equipment and handled independently.

In particular, if CID 1 occupies a traffic slot for a data transmission for Connection 1 between the user equipment A and the user equipment B, the traffic slot is occupied using CIDs assigned to Connection 1 between the user equipment A and the user equipment B. Subsequently, a rate scheduling (Tx pilot transmission and reception feedback (CQI) transmission) between the user equipment A and the user equipment B is performed.

Yet, although a data size for Connection 1 between the user equipment A and the user equipment B may not be considerable and data for Connection 2 between the user equipment A and the user equipment B may stand by at a buffer, since the corresponding traffic slot is occupied as a resource for Connection 1, a traffic slot should be newly occupied for a data transmission for Connection 2 through a new contention in a next traffic slot or interval.

In case of data for different connections despite the same source/destination, when data, which is transmittable using a traffic slot occupied between two user equipments, is transmitted by concatenation, a D2D traffic slot can be used more efficiently. Hence, it is necessary to define a method for the same. Informations required for a communication between D2D user equipments in an autonomous D2D communication type system may include a channel state information between the D2D user equipments, a physical information such as a distance and the like, etc. While a connection to a specific D2D user equipment is established, the corresponding value is maintained as a same value between the D2D user equipments.

Although different connections are established between two D2D user equipments, physical information (e.g., a channel state information, a distance value, etc.) measured between the two user equipments maintains the same value for the different connections. In spite that physical information between D2D user equipments can be transmitted once, if n connections are established between the same D2D user equipments, overall system performance may be degraded by performing a same information transmission/procedure n times.

According to a related art, in case that a new connection is added despite a presence of a connection already established between the same user equipments it is necessary to newly set a CID by repeatedly performing a CID setting process for the additional connection. Despite that Connection 1 is established between the user equipment A and the user equipment B, it is necessary to perform a basic D2D procedure such as a discovery between two user equipments, a paging between two user equipments and the like. This substance is applicable to a D2D communication. As an unnecessary resource use or an additional procedure execution is performed between D2D user equipments configured to perform a D2D communication, it may degrade overall system performance.

The present specification proposes a method of assigning a connection identifier (e.g., a connection ID, a link ID, a flow ID, etc.) to perform a D2D communication efficiently in a wireless communication system (e.g., a D2D system, a P2P system, etc.) capable of performing a D2D direct communication.

Link ID between D2D User Equipments

According to the technology of the present invention, before identifying at least one connection established between D2D user equipments, it is proposed to set up and use a link ID for a link identification between D2D user equipments.

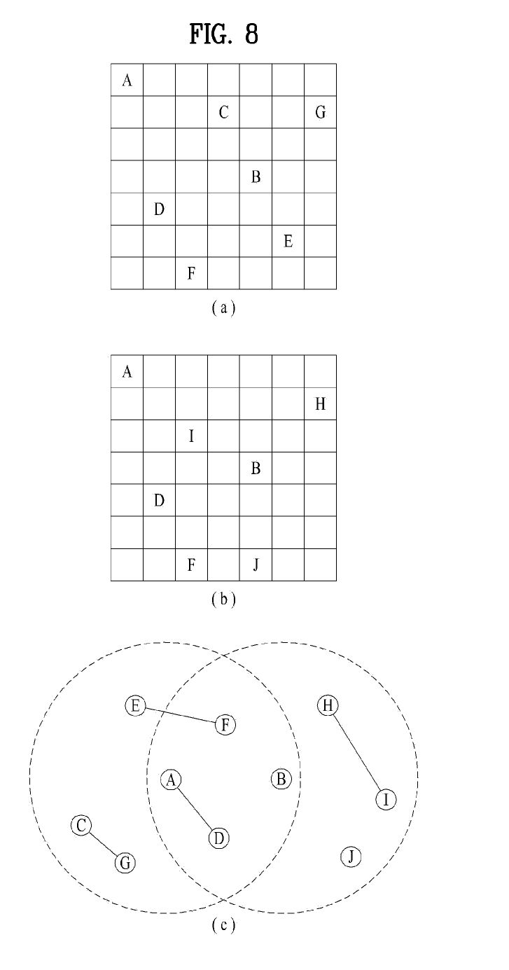

FIG. 7 is a diagram for one example to describe a link ID setup between D2D user equipments.

Referring to FIG. 7, although Connection 1 and Connection 2 exist between a D2D user equipment A (denoted by A) and a D2D user equipment B (denoted by B), both of the Connection 1 and the Connection 2 are set to recognize a link between the D2D user equipment A and the D2D user equipment B only using Link ID 1. Connections established between the D2D user equipment A and a D2D user equipment C (denoted by C) can be set to Link ID 2. Moreover, Link ID should have a unique value within two D2D user equipment coverages in a D2D communication system. Such Link ID can be set by one of the following methods.
1. D2D user equipment monitors a discovery slot, performs a paging (i.e., a paging preferably means a procedure for awaking a counterpart node by a fast paging and then receiving an awake response from the counterpart node), and monitors an LID broadcast. In particular, the object of the LID broadcast monitoring is described as follows. First of all, the D2D user equipment listens to an LID currently used by another D2D user equipment in an LID broadcast slot and broadcasts an LID currently used by itself. Thereafter, the D2D user equipment is able to set a Link ID by transmitting an unused LID and then receiving a selected LID.

2. D2D user equipment monitors a discovery slot, performs a paging (i.e., a paging preferably means a procedure for awaking a counterpart node by a fast paging and then receiving an awake response from the counterpart node), and is able to set a Link ID previously defined between two nodes.

It is proposed to use LID for a traffic occupancy between two nodes or a transmission of physical information (e.g., channel state4 information, HARQ, power control related information, etc.) between two nodes.

### Connection ID Settings Between D2D User Equipments

If at least one connection exists between two D2D user equipments, a method of identifying a link ID used for the technology of the present invention is required. One D2D user equipment can have at least one link to at least one D2D user equipment and can have multiple connections within the at least one link. Hence, a method of identifying the multiple connections in a MAC (medium access control) (or RLC (radio link control)) PDU (protocol data unit) header is necessary.

It is proposed for a MAC or RLC PDU header to use a connection ID generated from combining Link ID and Flow ID together (i.e., CID=LID (or Source ID)+FID). Since one D2D user equipment may have a connection to at least one other D2D user equipment, it is necessary for an identifier, which includes all Flow ID between a counterpart D2D user equipment and the corresponding D2D user equipment, to be included in a header. In this case, CID can use a source or destination ID instead of LID.

Link ID (LID) Setting Method 1

According to a 1^{st} LID setting method, LID can be set by a combination of a source ID and a destination ID.

LID is sorted into a source ID and a destination ID, which may be a source ID and a destination ID set in accordance with a tone slot location of each D2D user equipment discovered from a discovery slot or a unique identifier of a user equipment carried on a beacon signal. In particular, a unique identifier of a user equipment preferably has a unique value only among neighbor D2D user equipments that recognize signals of two D2D user equipment, may include a globally unique value in a D2D network, or may mean a MAC address.

According to a 2^{nd} LID setting method, a predefined LID is implicitly set in accordance with two D2D user equipment signals (e.g., a tone or beacon signal) in a discovery slot. In order to support this method, a location of a D2D user equipment signal in a discovery slot should be designed to avoid collision between neighbor D2D user equipments.

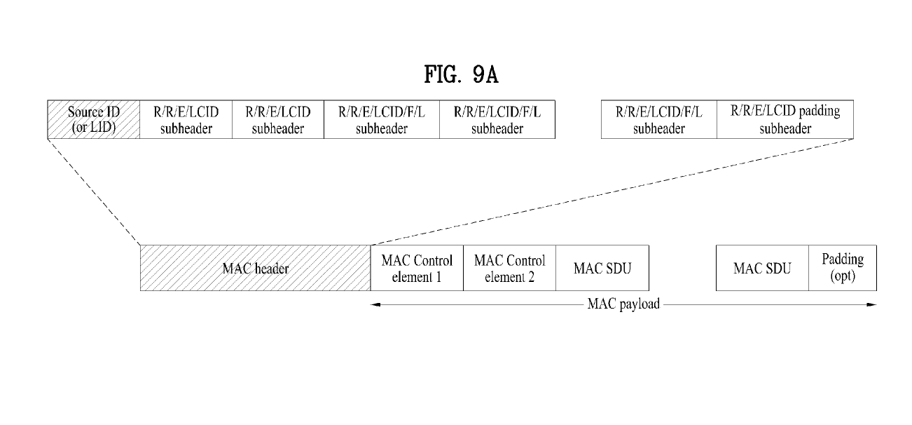

FIG. 8 is a diagram for one example to describe Link ID Setting Method 1.

FIG. 8(a) and FIG. 8(b) are diagrams of discovery slots discovered by a D2D user equipment A and a D2D user equipment B, respectively. And, FIG. 8(c) is a diagram of a location scenario of user equipments neighboring to a D2D user equipment A and a D2D user equipment B.

Referring to FIG. 8(a) and FIG. 8(b), although a D2D user equipment G (denoted by G) and a D2D user equipment H (denoted by H) use the same signal slot, a D2D user equipment F (denoted by F) or a D2D user equipment D (denoted by D) is unable to be simultaneously connected to the D2D user equipment G or the D2D user equipment H (denoted by H). In particular, in case that the D2D user equipment G or the D2D user equipment H monitors a discovery slot of its own, the D2D user equipment G or the D2D user equipment H can search either the D2D user equipment G or the D2D user equipment H. Since two D2D user equipments recognize each other through a discovery slot and the corresponding slot uses a tone slot unused by neighbor nodes of the two D2D user equipments, LID according to a location of the tone slot can be regarded as unique around the two D2D user equipments. In particular, a predefined LID is implicitly set by the rule determined between the nodes in a discovery interval.

Link ID (LID) Setting Method 2

A related art CID selecting method can be used for LID. Each neighbor D2D user equipment notifies an LID currently used by itself through an LID broadcast interval. Each D2D user equipment attempting to set a new LID selects one of LIDs currently unused in the LID broadcast interval. This can be performed through a paging interval as well.

Link ID (LID) Setting Method 3

Moreover, it is able to consider a method of setting an LID through a base station. LID of two D2D user equipments can be set through a base station. If receiving a paging response from a target (or destination) user equipment, a source user equipment makes a request for an LID, which is to be used between the two user equipments, to a base station. If so, the base station selects an LID currently unused around the two user equipments and is then able to assign the selected LID to the two user equipments.

Connection ID (CID) Setting Method

In case of B2D system, if data transmitted with an ID (e.g., C-RNTI (cell-radio network temporary identifier) in LTE system, STID (station identifier) in IEEE 802.16m system, etc.) of a user equipment exists, the user equipment receives the corresponding data and recognizes a connection for the corresponding data through a header. Since a transmitter is determined as a base station (e.g., ABS, node-B, etc.), the user equipment receives the data transmitted to itself and then identifies the correction for the corresponding data only.

Yet, in case of D2D system, although a D2D user equipment recognizes data destined for the corresponding D2D user equipment using a link ID (LID) and then receives the corresponding data, there may exist at least one transmitter transmitting the data. Hence, although the D2D user equipment receives the data using a unique link ID (LID), it may be necessary for the D2D user equipment to recognize that the corresponding data corresponds to a prescribed flow transmitted from a prescribed user equipment.

Therefore, it is proposed to use the corresponding technology for a flow ID in a header as well as a link ID. One embodiment of the use is described as follows.

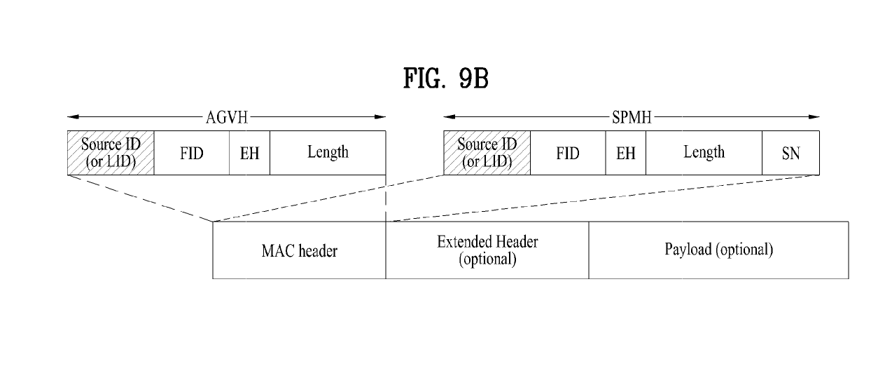

FIG. 9A is a diagram of a MAC PDU structure including a MAC header in LTE system.

Referring to FIG. 9A, MAC PDU in LTE system includes a MAC header and a MAC payload. In an existing LTE system, a source ID (LID) is not carried on a MAC header. Yet, in D2D communication, it is necessary for a source ID (LID) to be included in a D2D communication. In this case, for a data reception of a D2D user equipment in a D2D system, it is necessary for a MAC header to further include a link ID (LID) as well as a logical channel ID (LCID). If a MAC header is transmitted in a manner of including a link ID and a flow ID together, it is able to identify that a corresponding data is a prescribed flow transmitted from a prescribed D2D user equipment.

FIG. 9B is a diagram of a MAC data structure including a MAC header in IEEE 802.16m system.

Referring to FIG. 9B, a MAC header includes an advanced generic MAC header (AGMH) and a short packet MAC header (SPMH). Each of the advanced generic MAC header (AGMH) and the short packet MAC header (SPMH) includes a flow ID (FID). Likewise, in order to identify that a data corresponds to a prescribed follow transmitted from a prescribed D2D user equipment in a D2D system, it is necessary for each of the AGMH and the SPMH to be transmitted in a manner of further including a source ID (or LID).

Data Transmission Using Multiple CIDs

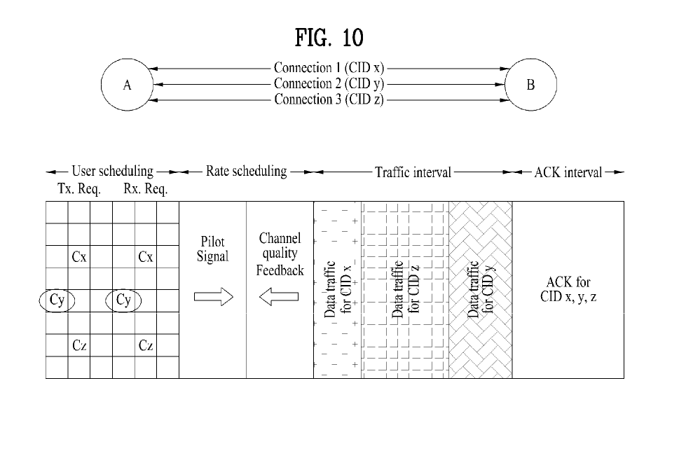

If at least one connection exists between two D2D user equipments, at least one CID set with a same user equipment can be used as multiple CID in a corresponding link despite using an existing CID scheme. FIG. 10 is a diagram for one example to describe a data transmitting method using multiple CIDs.

Referring to FIG. 10, if at least one connection exists between a D2D user equipment A (denoted by A) and a D2D user equipment B (denoted by B) and n CIDs are set for this, the D2D user equipment A and the D2D user equipment B can use the n CIDs in transceiving data for n connections. In a traffic slot occupied for the n CIDs, the D2D user equipment A and the D2D user equipment B freely transceive the data for the n connections through concatenation or packing in accordance with a scheduling of a transmitting D2D user equipment. In particular, CID x, CID y and CID z are IDs assigned to Connection 1, Connection 2 and Connection 3 between the D2D user equipment A and the D2D user equipment B, respectively. The D2D user equipment A or the D2D user equipment B is able to use all the CID x, CID y and CID z for data transmissions for Connection 1, Connection 2 and Connection 3. If any one of CID x, CID y and CID z occupies a traffic slot, the transmitting D2D user equipment can perform the data transmissions for Connection 1, Connection 2 and Connection 3 using resources of the corresponding traffic interval.

Channel State Information Transmitting (e.g., Rate Scheduling) Method Using Link ID or CID

Conventionally, a traffic slot performs a rate scheduling on a CID (or LID) occupying the traffic slot in a user scheduling slot and then performs a data transmission/reception. Yet, it is proposed that D2D user equipments can transmit channel state information for CID (or LID) failing to occupy a traffic slot. Thus, by transmitting channel state information between D2D user equipments periodically (or intermittently), a distance and channel state between user equipments are measured as well as the data transmission/reception, they can be used as values in maintaining a currently established connection or detecting a link failure.

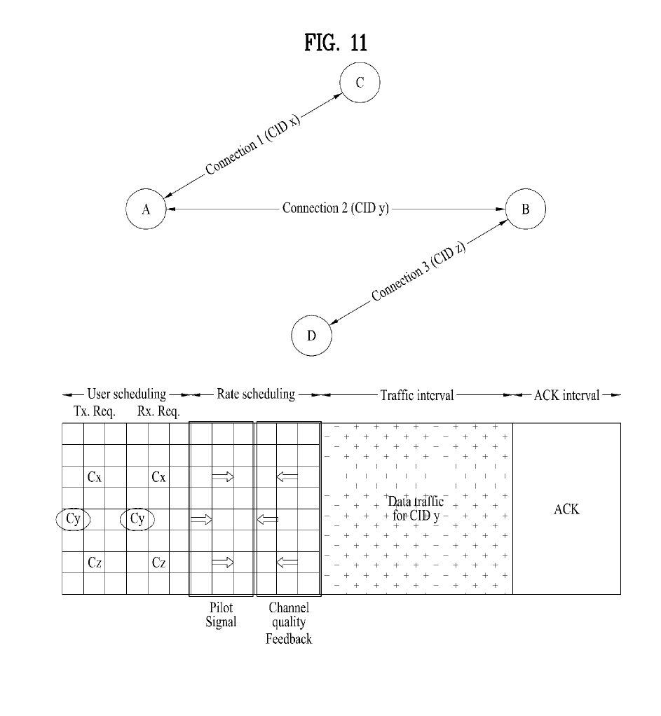

FIG. 11 is a diagram for one example to describe a channel state transmitting method using Link ID or CID.

Referring to FIG. 11, there are a D2D user equipment A (denoted by A), a D2D user equipment B (denoted by B), a D2D user equipment C (denoted by C), and a D2D user equipment D (denoted by D). If 3 connections exist, as shown in FIG. 11, the 3 connections may attempt to occupy a traffic slot. Yet, only CID y occupies a traffic interval. In this case, according to a related art, a pilot is transmitted in a signal tone corresponding to the CID y in a rate scheduling and a CQI feedback can be received. Yet, for the case mentioned in the above description, a pilot signal for CID z or CID z may be transmitted as well. This is applicable to all user equipments having CID (or LID) assigned thereto as well as to the D2D user equipment attempting to occupy the traffic slot. In this case, the above CID may include a CID between the same D2D user equipments or a CID between different D2D user equipments. In case of meaning CID or LID, a corresponding channel state information is applied to a connection or link failing to be transmitted in the traffic interval.

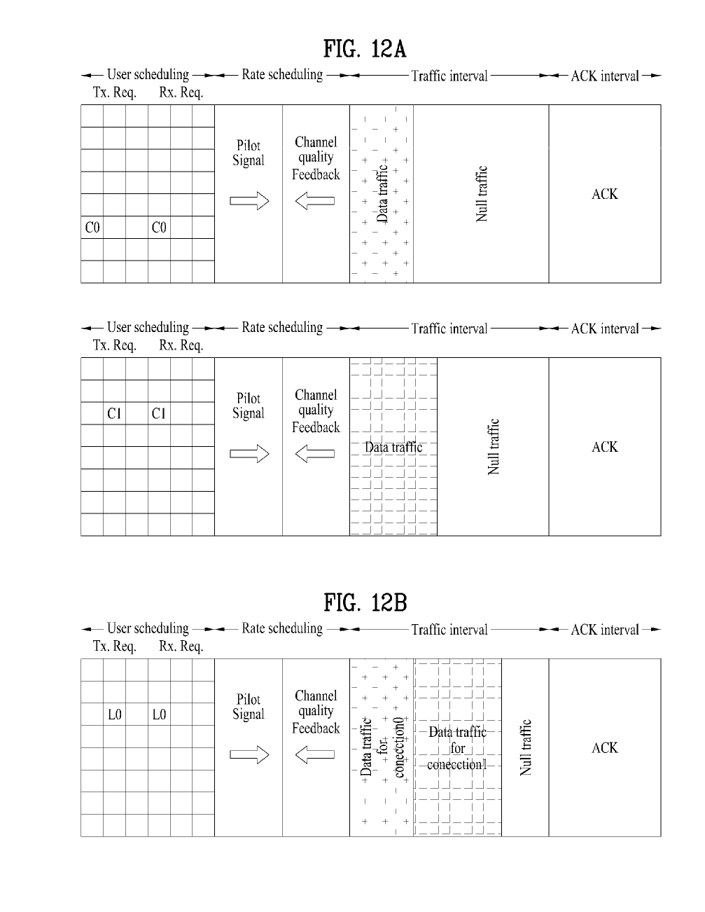

FIG. 12A is a diagram to describe a method of performing a data communication between user equipments according to a related art. And, FIG. 12B is a diagram to describe a method of performing a data communication between D2D user equipments.

Referring to FIG. 12A, Connection 0 (C0) and Connection 1 (C1) are established between a user equipment A and a user equipment B. One connection is transceived between the user equipment A and the user equipment B through a traffic interval and another connection is transceived through another traffic interval.

On the other hand, referring to FIG. 12D, Link ID 0 is established between a user equipment A and a user equipment B. Connection 0 (C0) and Connection 1 (C1) are established. If a scheduling for a UE-to-UE data communication performed for a D2D communication is performed per user equipment link, when at least one connection exists between two user equipments, a user scheduling and a rate scheduling, which were performed multiple times as many as the number of connections, can be performed at a time and a transmitter can set and transmit a data size, which is to be transmitted in an occupied traffic slot, in accordance with QoS per connection. Therefore, a system resource use rate can be raised.

According to the embodiments of the present invention mentioned in the foregoing description, as a system resource use efficiency is raised, system performance is enhanced.

The above-mentioned embodiments correspond to combinations of elements and features of the present invention in prescribed forms. And, it is able to consider that the respective elements or features are selective unless they are explicitly mentioned. Each of the elements or features can be implemented in a form failing to be combined with other elements or features. Moreover, it is able to implement an embodiment of the present invention by combining elements and/or features together in part. A sequence of operations explained for each embodiment of the present invention can be modified. Some configurations or features of one embodiment can be included in another embodiment or can be substituted for corresponding configurations or features of another embodiment. And, it is apparently understandable that an embodiment is configured by combining claims failing to have relation of explicit citation in the appended claims together or can be included as new claims by amendment after filing an application.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

Accordingly, a method for a D2D user equipment to set a link identifier in a wireless communication system supportive of a D2D (device-to-device) communication is industrially applicable to various kinds of communication systems including 3GPP LTE, 3GPP LTE-A, IEEE 802 and the like.

What is claimed is:

1. A method of setting a link identifier by a D2D user equipment in a wireless communication system supportive of a D2D (device-to-device) communication, the method comprising:
searching neighbor D2D user equipments through a discovery slot; and
establishing a D2D user equipment link by selecting a specific D2D user equipment from the neighbor D2D user equipments and setting the link identifier between the D2D user equipment and the linked D2D user equipment,
wherein the link identifier is set using identifiers of the linked two D2D user equipments or set to a predefined link identifier in accordance with a location of a signal of the linked two D2D user equipments within the discovery slot.

2. The method of claim 1, wherein if the link identifier uses the identifiers of the liked two D2D user equipments or is set, the link identifier is configured with a combination of the identifiers of the linked two D2D user equipments.

3. The method of claim 1, wherein the set link identifier comprises one of a unique value in a coverage of the two D2D user equipments and a MAC (media access control) address.

4. The method of claim 1, further comprising:
transmitting data including the set link identifier.

5. A method of setting a link identifier by a D2D user equipment in a wireless communication system supportive of a D2D (device-to-device) communication, the method comprising:
searching neighbor D2D user equipments through a discovery slot;
establishing a D2D user equipment link by selecting a specific D2D user equipment from the neighbor D2D user equipments;
requesting a base station to assign a link identifier to use between the linked D2D user equipments; and
receiving the assigned link identifier from the base station and setting the received link identifier as the link identifier for the two D2D user equipments,
wherein the set link identifier is selected from unused link identifiers neighboring to the two D2D user equipments.

6. A D2D (device-to-device) user equipment of setting a link identifier in a wireless communication system supportive of a D2D communication, the D2D user equipment comprising:
a processor configured to:
search neighbor D2D user equipments through a discovery slot, the processor configured to establish a D2D user equipment link by selecting a specific D2D user equipment from the neighbor D2D user equipments,
set the link identifier between the D2D user equipment and the linked D2D user equipment,
wherein the link identifier is set using identifiers of the linked two D2D user equipments or set to a predefined link identifier in accordance with a location of a signal of the linked two D2D user equipments within the discovery slot.

7. The D2D user equipment of claim 6, wherein if the link identifier uses the identifiers of the liked two D2D user equipments or is set, the link identifier is configured with a combination of the identifiers of the linked two D2D user equipments.

8. The D2D user equipment of claim 6, further comprising:
a transmitter configured to transmit data including the set link identifier.

9. A D2D (device-to-device) user equipment of setting a link identifier in a wireless communication system supportive of a D2D communication, the D2D user equipment comprising;
a transmitter;
a receiver; and
a processor configured to:
search neighbor D2D user equipments through a discovery slot,
establish a D2D user equipment link by selecting a specific D2D user equipment from the neighbor D2D user equipments,
wherein the processor is further configured to control the transmitter to request a base station to assign a link identifier to use between the linked D2D user equipments, the processor is further configured to control the receiver to receive the assigned link identifier from the base station, the processor is further configured to set the received link identifier as the link identifier for the two D2D user equipments,
wherein the set link identifier is selected from unused link identifiers neighboring to the two D2D user equipments.
